(19) United States
(12) Patent Application Publication
(10) Pub. No.: US 2007/0245262 A1
(43) Pub. Date: Oct. 18, 2007

(54) Method for Controlling Access to Digital Content When Using a Mouse with Two Buttons

(76) Inventor: Heinz Scheuring, Mohlin (CH)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/573,398

(22) PCT Filed: Jul. 26, 2005
(86) PCT No.: PCT/EP05/53643

§ 371 Date: Feb. 8, 2007

(30) Foreign Application Priority Data
Aug. 9, 2004 (DE) 10 2004 038 772.9

(51) Int. Cl. G06F 3/048

(52) U.S. Cl. 715/810

(57) ABSTRACT

The invention relates to a method for accessing digital information content, with a computer system which has a display unit, wherein a menu which can be changed by a user is opened by clicking a first object, wherein the menu provides one or more references to one or more further objects which are opened by selecting the reference, and thus goes beyond the display of properties or functions of the first object, as a result of which the relationship of the object to the further objects is determined.

The invention relates to a method and a system for controlling access to digital objects. In particular, the invention relates to a possibility of accessing digital objects by means of control with the mouse.

### FIELD OF THE INVENTION

In familiar Windows®-based systems, objects such as files are accessed by means of the left mouse button, wherein the right mouse button is used to display properties of the object or perform functions of the object. This right properties menu can only be expanded with difficulty by the user.

### OVERVIEW OF THE INVENTION

The object of the invention is to provide a method which enables fast and structured access to objects which are related to other objects.

This object is solved by an invention with the features of the independent claims. Further embodiments can be found in the subordinate claims.

The development of the specific “multi-link” is a prerequisite for a direct connection between data and knowledge where possible.

In contrast to the simple hyperlink, the system of the present invention is an entire “link system”. With the MetaLink, the user is given access to all relevant information and further documents which are important or useful for a specific document or a topic. Therein, the MetaLink can be administered by the normal user. No specific IT skills are required. This results in improved user-friendliness of the system. Record keeping is improved, as a result of which lower data redundancy is ensured. The loss of data is reduced.

The differences between traditional hyperlinks (HL) and the MetaLink (ML) according to the invention are described below. Both the HL and the ML offer access to the (main) document, but in a different form and level of complexity. The ML offers a wide range of accesses via sublinks, said accesses being provided in the form of a menu, e.g. to documents in MS Office, hyperlinks, starting programs.

A combined, e.g. project-specific, link to a document with universally valid expertise which can be used by everyone and further working aids can thus be easily achieved by means of the present invention.

The invention thus comprises a method for accessing digital information content, with a computer system having a display unit which can trigger two different actions, for example, via the left and the right mouse button. By clicking a first object, e.g. a file, e.g. by means of the right mouse button, a menu which can be changed by a user is opened. Therein, the menu provides one or more references to one or further objects which are opened by selecting the reference and thus goes beyond the display of the properties or functions of the first object, as is known in familiar systems e.g. Windows®, X-Windows®, Apple OS®. This defines the relationship of the object to the further objects and ensures fast access to the objects in that these can be opened e.g. by means of the left button or renewed, e.g. it is possible to jump up a hierarchy level by means of the right button.

Examples of alternative triggering possibilities include:
Simple reversion: right mouse button opens main document, left button the menu
Left mouse button only positions, double-click opens the main document, right mouse button leads to the menu
Left mouse button directly opens the menu, wherein not only the sublinks but also the main document are offered;
The menu with the sublinks is not controlled with the right mouse button, but rather by means of a combination of the left or right mouse button with a keyboard key (e.g. right mouse button+Ctrl)

As well as the reference to similar objects, it is intended that the objects are files, computers, documents, SQL queries, executable programs, HTML references, projects. Further alternatives are conceivable herein.

Different versions of an object can also be referenced so that the history of the objects is displayed, wherein the previous version can be respectively seen in the menu. Herein, the history of the objects is preferably displayed hierarchically.

A comparison of the objects in terms of changes can be carried out by means of an additional function which can be embedded in the menu, e.g. a link to a program to which parameters are transferred.

In order to control changes to the menu and control access to the objects, user rights can be assigned for access to objects or for the expansion of the objects. Herein, the objects or the functions are shown as inactive or hidden. Rights administration is preferably performed at the operating system level in combination with a further table in which the rights for each object and the menu items are stored. The rights in the menu control are therein also transferred immediately to the object itself, e.g. to the rights of the file, so that there is no need for rights administration on two levels.

The user rights can be set via the menu, wherein the owner of the object controls the assignment of rights. All these settings can be individually expanded via the menu itself by actuating a function in the menu or via a further context menu, wherein the menu can look different for each user of the object. It is thus furthermore conceivable that further information can be stored in a menu item such as date, status, category, owner, last editor, etc.

For simple operation, an expansion of the menu by means of drag and drop is also conceivable. Herein, one object is shifted to the other. Therein, the menu opens automatically and the object can be moved to the desired item. Alternatives are conceivable, such as prior opening and anchoring of the menu.

In order to improve generation, menu templates are predefined for a plurality of objects. These are assigned to the object types. These templates comprise a range of links, objects and object references as well as other menu items. In the case of templates, it is always advantageous to differentiate between references and real objects. On the one hand, a reference or a link is generated, on the other, also the object.

In order to avoid redundancy, an automatic check is performed for multiple filings of documents. This can be carried out at night during generation or in a batch run.

The menu can be operated in a variety of ways. E.g. after opening the menu, an individual item can be selected with the left button of the mouse. The individual hierarchy is displayed by lingering on the item for a longer period or approaching it or by pressing the left button of the mouse again.

This approach is solved in technical terms by means of an Explorer-type program which also stores the content of the menu for each object in a database. Herein, the objects are linked to the menu items by means of a unique handle. A simple relationship is sufficient for this purpose.

Possible applications include integration into a conventional user interface such as Windows or in a file browser.

A further component of the invention is a method for checking the consistency of the link for a menu, wherein it is checked whether the reference is still valid or is broken. If the reference is broken, a search is performed using an identification number in the file or a hash value of the object as to whether a corresponding object has been stored at another location or renamed or the directory has been changed in order then to correctly re-establish the reference. The identification number or the hash value are administered in the database together with the links.

In addition, one or more of the following properties can be taken into account during the search for an object: date of creation of the object, date of amendment of the object, name of the object, storage location of the object, author of the object, creator of the object.

If there is lack of unambigiity, the user is provided with a selection of objects from which he can select one in order to repair the link.

### DESCRIPTION OF THE DRAWINGS

The invention is described in greater detail below on the basis of exemplary embodiments which are shown schematically in the figures. Therein, the same reference numbers in the individual figures designate the same elements. More precisely:

FIG. 1 shows an application scenario in a project administration, in which a menu, in which knowledge is stored, is opened by clicking with the right mouse button;

FIG. 2 shows a view of a dialogue box for processing a MetaLink

FIG. 3 shows an example of a mask for the re-establishment of the hyperlink;

FIG. 4 shows a tiered view of the system according to the invention.

### DESCRIPTION OF A POSSIBLE EMBODIMENT

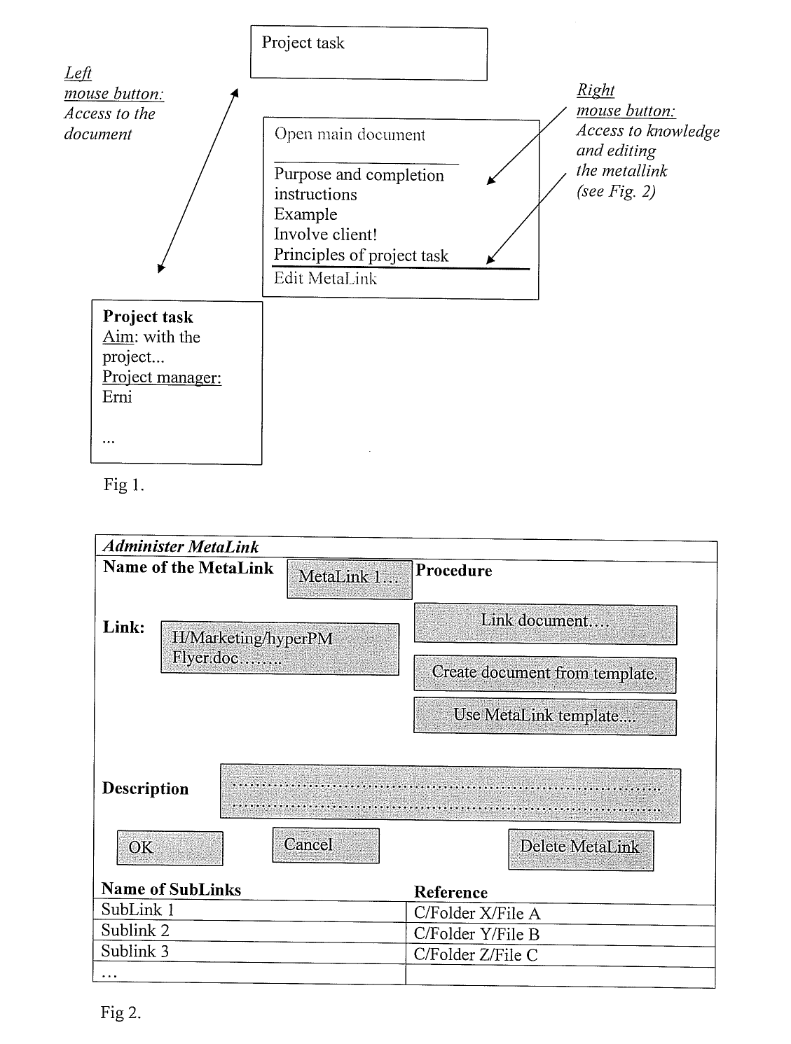

FIG. 1 shows an example of a configuration according to the invention of a menu using the example of a project system. Herein, the project task is the object. The project task document can be opened with the left mouse button. The context menu according to the invention is opened with the right mouse button and can be edited. In the present example, it is used for the purpose of identifying the document, displaying examples for this purpose and finding out about principles of the project task. This involves further documents which can be selected and are displayed when they have been selected.

FIG. 2 contains a view of a dialogue for editing the MetaLink or reference. General data of the MetaLink (e.g. name and description) and the reference to the main document are defined in the upper half of the dialogue mask. The reference to the main document can be generated by setting a reference to an existing document, by generating a copy from a document template, by using a MetaLink template comprising a (main) document and one or more predefined sublinks. The sublinks can be defined in the lower half of the dialogue mask with their names and with the references.

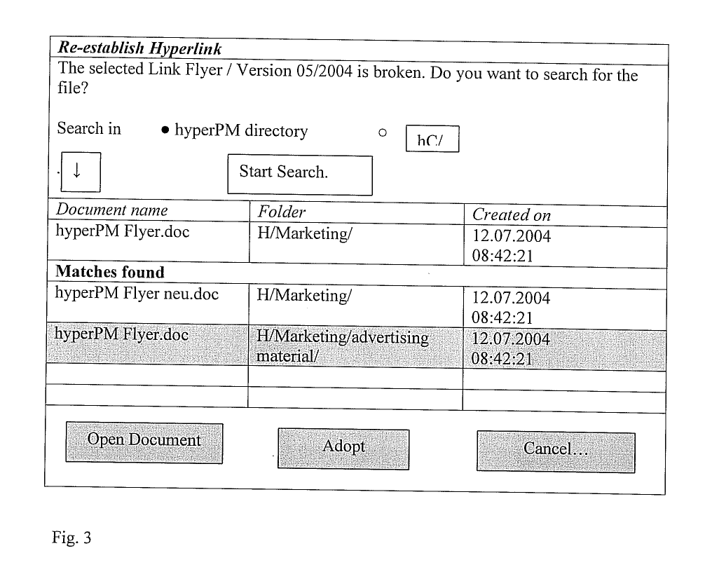

FIG. 3 shows a mini-view of a system which looks for defective hyperlinks in order to re-establish them. Herein, the search is restricted to specific areas on the hard disk system or another data storage device. Should defective hyperlinks be found, the user is provided with the required information in a selection menu so that he can interactively re-establish the link.

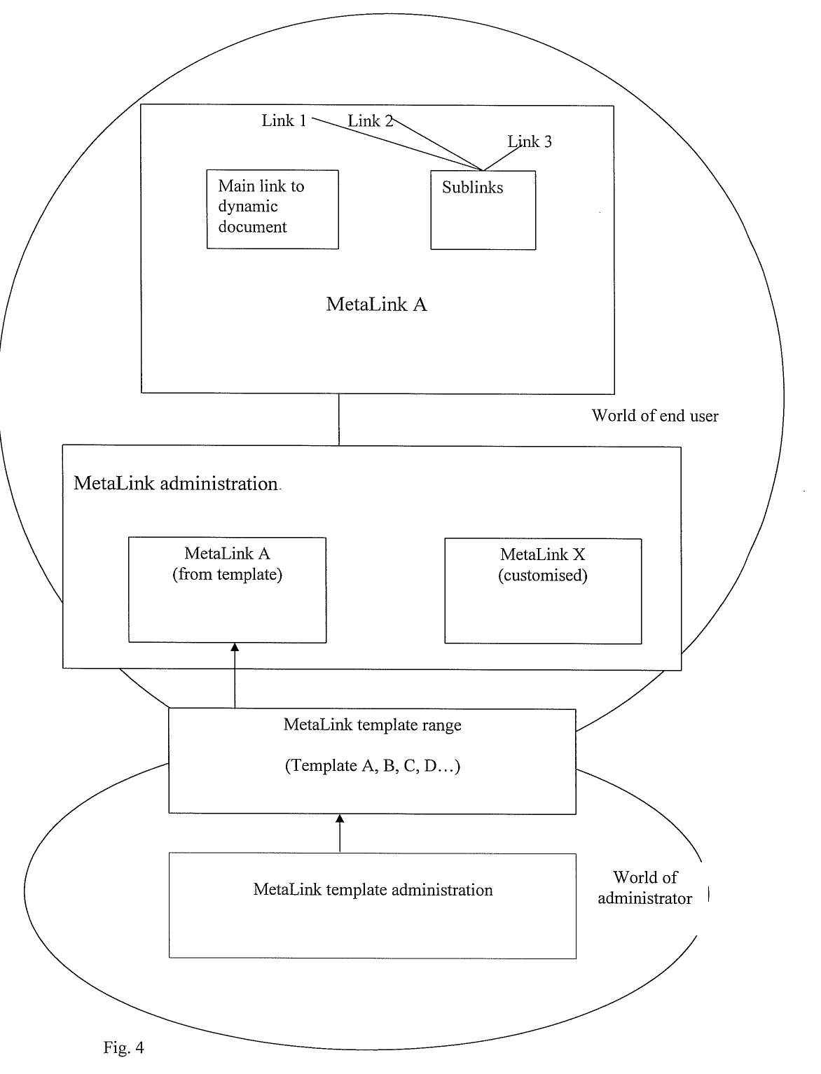

FIG. 4 shows a tiered structure of the present invention. Herein, a differentiation is made between the world of the administrator and the world of the end user. The templates for the individual objects are administered in the environment of the administrator. These are provided to the end user in the MetaLink administration which is preferably configured as a database. As well as using templates, the user can create individual MetaLinks comprising a main document and sublinks. The individual documents are subsequently accessed via the links, as described above.

1. A method for accessing digital information content, with a computer system having a display unit with which various mouse actions can be triggered, wherein a first mouse action in relation to a view of a target object is used to open a target object, wherein
a menu which can be changed by a user is called up with another mouse action, wherein the menu provides one or more references which can be added to one or more further target objects which are opened by selecting the reference.

2. The method according to claim 1, wherein the menu with the references is opened by means of the following options or a combination of mouse action thereof: single or double clicking or the left or right mouse button or combinations of left or right mouse button or with a keyboard command.

3. The method according to o claim 1, wherein the objects are one or more from the multitude of files, file directories, documents, SQL or other database queries, executable programs, HTML references, URL addresses, program interfaces predefined views.

4. The method according to claim 1, wherein the history of the objects is displayed, wherein the previous version can respectively be seen in the menu.

5. The method according to claim 4, wherein the history of the objects is displayed hierarchically.

6. The method according to claim 4, wherein a comparison of the objects in terms of changes can be carried out.

7. The method according to claim 1, wherein the user rights for access to objects or for the expansion of the objects can be set.

8. The method according to claim 7, wherein the user rights can be set via the menu, wherein the owner of the object controls the assignment of rights.

9. The method according to claim 1, wherein it can be individually expanded by means of the menu itself by actuating a function in the menu or via a further context menu.

10. The method according to claim 1 wherein the menu can be expanded by means of drag and drop.

11. The method according to claim 1, wherein further information can be stored in a menu item from the multitude of date, status, category, access rights.

12. The method according to claim 1, wherein templates are stored for an object type, wherein the menus are already provided with references.

13. The method according to claim 1, wherein, in order to avoid redundancy, an automatic check is performed for multiple filings of documents.

14. The method according to claim 1, wherein, after opening the menu, a single item is selected with the left button of the mouse.

15. The method according to claim 1, wherein the display of individual hierarchies by lingering on the item for a longer period or approaching it or by pressing the left button of the mouse again.

16. The method according to claim 1, wherein a database orientation in which the information of the menu is stored for each object of its unique label.

17. The method according to claim 1, wherein integration into a file browser, project browser or Internet browser.

18. The method according to claim 1, wherein the consistency of the link is checked comprising the following steps:
wherein a check is performed as to whether the reference is still valid or is broken, and
if the reference is broken, a search is performed for the object using an identification number in the file or a hash value of the object in order to correctly re-establish the reference, wherein the identification number or the hash value is stored in the database which administers the links.

19. A method for checking the consistency of the link
wherein a check is performed as to whether the reference is still valid or is broken, and
if the reference is broken, a search is performed for the object using an identification number in the file or a hash value of the object in order to correctly re-establish the reference, wherein the identification number or the hash value is stored in the database which administers the links.

20. Method for checking the consistency of the link according to the preceding claim 19, wherein, in addition, one or more of the following properties are taken into account during the search for an object: date of creation of the object, date of amendment of the object, name of the object, storage location of the object, author of the object, creator of the object.

21. Method for checking the consistency of the link according to claim 19, wherein, if there is lack of unambiguity, the user is provided with a selection of objects from which he can select one in order to repair the link.

22. Data carrier for a computer, comprising a data structure when loaded into a computer the storage of software according performing a method according to claim 1.

23. Computer system with a display device, a memory, a mouse, and a processing unit, which enables the user to access digital information content, wherein a first mouse action in relation to a view of a target object is used to open a target object, wherein
a menu which can be changed by a user is called up with another mouse action, wherein the menu provides one or more references which can be added to one or more further target objects which are opened by selecting the reference.
